(19) United States
(12) Patent Application Publication
(10) Pub. No.: US 2010/0119897 A1
(43) Pub. Date: May 13, 2010

(54) HYDROGEN FUEL CELL SYSTEMS

(75) Inventors: Chih-Yen Lin, Taoyuan County (TW); Hsin-Chou Chen, Taoyuan County (TW); Chiang-Wen Lai, Taoyuan County (TW); Yu-Chun Ko, Taoyuan County (TW)

Correspondence Address: QUINTERO LAW OFFICE, PC, 615 Hampton Dr, Suite A202, Venice, CA, 90291, US

(73) Assignee: NAN YA PCB CORP., Taoyuan County (TW)

(21) Appl. No.: 12/393,944

(22) Filed: Feb. 26, 2009

(30) Foreign Application Priority Data
Nov. 7, 2008 (TW) TW97143026

(51) Int. Cl. H01M 8/18

(52) U.S. Cl. 429/21

(57) ABSTRACT

A hydrogen fuel cell system. A gas/water distributor connects to a hydrogen fuel cell module. A hydrogen input pipe connects to the gas/water distributor, inputting hydrogen thereinto. A reservoir receives water. A water input pipe connects the gas/water distributor to the reservoir. A pump is connected to the water input pipe, transporting the water from the reservoir to the gas/water distributor. A gas/water confluent device connects to the hydrogen fuel cell module. The hydrogen fuel cell module is disposed between the gas/water distributor and the gas/water confluent device. An output pipe connects the gas/water confluent device to the reservoir.

### CROSS REFERENCE TO RELATED APPLICATIONS

This Application claims priority of Taiwan Patent Application No. 097143026, filed on Nov. 7, 2008, the entirety of which is incorporated by reference herein.

### BACKGROUND OF THE INVENTION

1. Field of the Invention

The invention relates to hydrogen fuel cell systems, and more particularly to hydrogen fuel cell systems with enhanced operational efficiency.

2. Description of the Related Art

Generally, in a fuel cell employing hydrogen (H₂) as fuel, the equation for a redox reaction at a cathode side and an anode side is as follows.

At the anode side: H₂→2H⁺+2e⁻;

At the cathode side: 1/2O₂+2H⁺+2e⁻→H₂O.

Specifically, in the aforementioned fuel cell, hydrogen is carried by water steam to the anode side for reaction. Here, the water steam serves as a carrier and provides functions of enhancing conductivity and reducing reaction temperature. Accordingly, a hydrogen fuel cell is commonly used with a humidifier.

Referring to FIG. 1, a conventional humidifier 1 for a hydrogen fuel cell comprises a reservoir 11, an input pipe 12, an output pipe 13, a heater 14, a temperature controller 15, a thermal insulation member 16, a thermometer 17, a level monitor 18, and a hygrometer 19.

The reservoir 11 receives water.

The input pipe 12 connects the reservoir 11 to a hydrogen supply source 2.

The output pipe 13 connects the reservoir 11 to a hydrogen fuel cell module 3.

The heater 14 is disposed in the reservoir 11.

The temperature controller 15 is electrically connected to the heater 14, controlling heating operation thereof.

The thermal insulation member 16 covers the output pipe 13.

The thermometer 17, level monitor 18, and hygrometer 19 are disposed in the reservoir 11, respectively detecting the water temperature, water level, and humidity in the reservoir 11.

When the humidifier 1 operates, the heater 14 heats the water in the reservoir 11 to a predetermined temperature, vaporizing the water into high-temperature steam. Hydrogen is then transported into the reservoir 11 from the hydrogen supply source 2 via the input pipe 12, mixing with the high-temperature steam. The mixed high-temperature steam and hydrogen are then transported to the hydrogen fuel cell module 3 via the output pipe 13, performing a redox reaction. Here, the thermal insulation member 16 covering the output pipe 13 can prevent condensation of the high-temperature steam during transportation thereof.

Following are some drawbacks of the conventional humidifier 1. Because the humidifier 1 must be equipped with the heater 14, temperature controller 15, thermal insulation member 16, thermometer 17, level monitor 18, and hygrometer 19, control thereof is complicated and overall manufacturing costs thereof is high. Moreover, when the humidifier 1 begins to operate, the hydrogen must be transported into the reservoir 11 only after the water temperature in the reservoir 11 reaches the predetermined temperature, consuming additional energy requiring additional time, and further delaying operation of the hydrogen fuel cell module 3.

### BRIEF SUMMARY OF THE INVENTION

A detailed description is given in the following embodiments with reference to the accompanying drawings.

An exemplary embodiment of the invention provides a hydrogen fuel cell system comprising a hydrogen fuel cell module, a gas/water distributor, a hydrogen input pipe, a reservoir, a water input pipe, a pump, a gas/water confluent device, and an output pipe. The gas/water distributor connects to the hydrogen fuel cell module. The hydrogen input pipe connects to the gas/water distributor, inputting hydrogen thereinto. The reservoir receives water. The water input pipe connects the gas/water distributor to the reservoir. The pump is connected to the water input pipe, transporting the water from the reservoir to the gas/water distributor. The gas/water confluent device connects to the hydrogen fuel cell module. The hydrogen fuel cell module is disposed between the gas/water distributor and the gas/water confluent device. The output pipe connects the gas/water confluent device to the reservoir.

The hydrogen fuel cell system further comprises an electromagnetic valve connected to the output pipe.

The hydrogen fuel cell system further comprises a controller electrically connected to the pump and electromagnetic valve, controlling operation thereof.

The hydrogen fuel cell system further comprises a check valve connected to the water input pipe and disposed between the reservoir and the pump.

The reservoir comprises an exhaust, discharging gas to the exterior of the reservoir.

The exhaust comprises a gas/liquid separation film.

Another exemplary embodiment of the invention provides a hydrogen fuel cell system comprising a hydrogen fuel cell module, a gas/water distributor, a hydrogen input pipe, a reservoir, a booster, a water input pipe, a gas/water confluent device, and a first output pipe. The gas/water distributor connects to the hydrogen fuel cell module. The hydrogen input pipe connects to the gas/water distributor, inputting hydrogen thereinto. The reservoir receives water. The booster is connected to the gas/water distributor. The water input pipe connects the reservoir to the booster, inputting the water from the reservoir into the booster and gas/water distributor. The gas/water confluent device connects to the hydrogen fuel cell module. The hydrogen fuel cell module is disposed between the gas/water distributor and the gas/water confluent device. The first output pipe connects the gas/water confluent device to the reservoir.

The hydrogen fuel cell system further comprises a second output pipe and an electromagnetic valve. The second output pipe is connected to the first output pipe. The electromagnetic valve is connected to the second output pipe.

The hydrogen fuel cell system further comprises a controller electrically connected to the electromagnetic valve and booster, controlling operation thereof.

The hydrogen fuel cell system further comprises a first check valve connected to the water input pipe.

The hydrogen fuel cell system further comprises a second check valve connected to the first output pipe.

### BRIEF DESCRIPTION OF THE DRAWINGS

The invention can be more fully understood by reading the subsequent detailed description and examples with references made to the accompanying drawings, wherein:

FIG. 1 is a schematic plane view of a conventional humidifier for a hydrogen fuel cell;

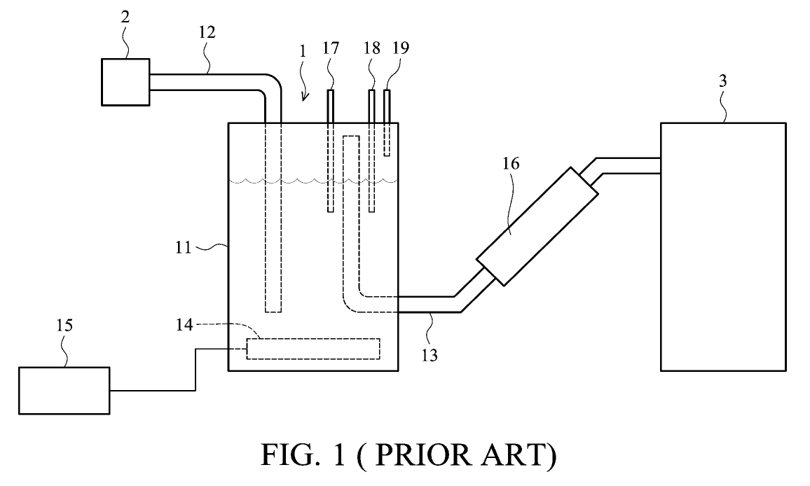

FIG. 2 is a schematic perspective view of a hydrogen fuel cell system of a first embodiment of the invention; and

FIG. 3 is a schematic perspective view of a hydrogen fuel cell system of a second embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

### First Embodiment

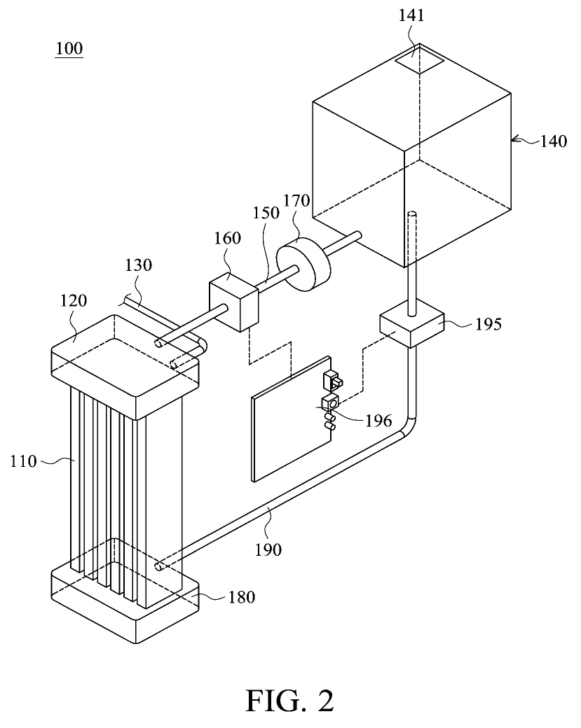

Referring to FIG. 2, a hydrogen fuel cell system 100 comprises a hydrogen fuel cell module 110, a gas/water distributor 120, a hydrogen input pipe 130, a reservoir 140, a water input pipe 150, a pump 160, a check valve 170, a gas/water confluent device 180, an output pipe 190, an electromagnetic valve 195, and a controller 196.

The gas/water distributor 120 connects to a top portion of the hydrogen fuel cell module 110. Here, multiple and multi-layered micro-channels (not shown) are provided in the gas/water distributor 120.

The hydrogen input pipe 130 connects a hydrogen supply source (not shown) to the gas/water distributor 120, inputting hydrogen thereinto. For example, the hydrogen may be input into bottom-layer micro-channels (not shown) of the gas/water distributor 120 via the hydrogen input pipe 130.

The reservoir 140 receives water and comprises an exhaust 141, discharging gas to the exterior of the reservoir 140. In this embodiment, the exhaust 141 may be a gas/liquid separation film.

The water input pipe 150 connects the gas/water distributor 120 to the reservoir 140.

The pump 160 is connected to the water input pipe 150, transporting the water from the reservoir 140 to the gas/water distributor 120. For example, the water may be transported from the reservoir 140 to top-layer micro-channels (not shown) of the gas/water distributor 120 by the pump 160.

The check valve 170 is connected to the water input pipe 150 and is disposed between the reservoir 140 and the pump 160. Here, by disposition of the check valve 170, the water can flow from the reservoir 140 to the gas/water distributor 120 and cannot flow from the gas/water distributor 120 to the reservoir 140.

The gas/water confluent device 180 connects to a bottom portion of the hydrogen fuel cell module 110. Here, the hydrogen fuel cell module 110 is disposed between the gas/water distributor 120 and the gas/water confluent device 180.

The output pipe 190 connects the gas/water confluent device 180 to the reservoir 140.

The electromagnetic valve 195 is connected to the output pipe 190.

The controller 196 is electrically connected to the pump 160 and electromagnetic valve 195, controlling operation thereof.

The following description is directed to operation of the hydrogen fuel cell system 100.

The hydrogen is input into the bottom-layer micro-channels of the gas/water distributor 120 using the hydrogen input pipe 130. At the same time, the controller 196 drives the pump 160 to operate, transporting the water from the reservoir 140 to the top-layer micro-channels of the gas/water distributor 120 via the water input pipe 150. Here, the water flowing through the top-layer micro-channels of the gas/water distributor 120 transforms into micro-drops approximating to water steam. The micro-drops approximating to water steam uniformly flow into the bottom-layer micro-channels of the gas/water distributor 120, uniformly mixing with the hydrogen. The uniformly mixed hydrogen and micro-drops then enter the hydrogen fuel cell module 110, performing a redox reaction. Specifically, partially unused hydrogen and micro-drops are collected by the gas/water confluent device 180 and further enter the output pipe 190. When the hydrogen and water accumulates to a specific level in the output pipe 190, the controller 196 drives the electromagnetic valve 195 to open, enabling the hydrogen and water to flow back into the reservoir 140. The hydrogen can then be discharged to the exterior of the reservoir 140 through the exhaust 141. Accordingly, by the controller 196 repeatedly controlling the operation of the pump 160 and electromagnetic valve 195, the redox reaction can be continuously performed in the hydrogen fuel cell module 110, outputting electric power.

### Second Embodiment

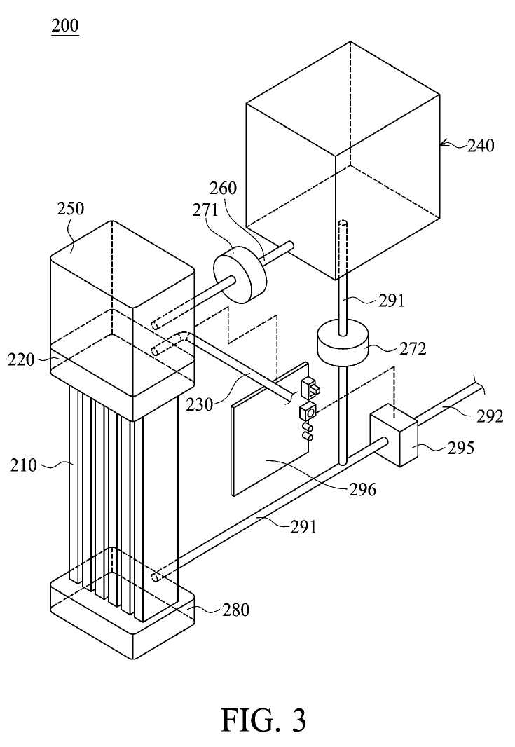

Referring to FIG. 3, a hydrogen fuel cell system 200 comprises a hydrogen fuel cell module 210, a gas/water distributor 220, a hydrogen input pipe 230, a reservoir 240, a booster 250, a water input pipe 260, a first check valve 271, a gas/water confluent device 280, a first output pipe 291, a second check valve 272, a second output pipe 292, an electromagnetic valve 295, and a controller 296.

The gas/water distributor 220 connects to a top portion of the hydrogen fuel cell module 210. Here, multiple and multi-layered micro-channels (not shown) are provided in the gas/water distributor 220.

The hydrogen input pipe 230 connects a hydrogen supply source (not shown) to the gas/water distributor 220, inputting hydrogen thereinto. For example, the hydrogen may be input into bottom-layer micro-channels (not shown) of the gas/water distributor 220 via the hydrogen input pipe 230.

The reservoir 240 receives water.

The booster 250 is connected to a top portion of the gas/water distributor 220.

The water input pipe 260 connects the reservoir 240 to the booster 250, inputting the water from the reservoir 240 into the booster 250 and gas/water distributor 220. For example, the water may be transported to top-layer micro-channels (not shown) of the gas/water distributor 220 via the booster 250.

The first check valve 271 is connected to the water input pipe 260. Here, by disposition of the first check valve 271, the water can flow from the reservoir 240 to the booster 250 and cannot reversely flow thereto.

The gas/water confluent device 280 connects to a bottom portion of the hydrogen fuel cell module 210. Here, the hydrogen fuel cell module 280 is disposed between the gas/water distributor 220 and the gas/water confluent device 280.

The first output pipe 291 connects the gas/water confluent device 280 to the reservoir 240.

The second check valve 272 is connected to the first output pipe 291. Here, by disposition of the second check valve 272, the water can flow from the gas/water confluent device 280 to the reservoir 240 and cannot reversely flow thereto.

The second output pipe 292 is connected to the first output pipe 291.

The electromagnetic valve 295 is connected to the second output pipe 292.

The controller 296 is electrically connected to the electromagnetic valve 295 and booster 250, controlling operation thereof.

The following description is directed to operation of the hydrogen fuel cell system 200.

The controller 296 drives the electromagnetic valve 295 to close. The hydrogen is then input into the bottom-layer micro-channels of the gas/water distributor 220 using the hydrogen input pipe 230. At the same time, the controller 296 drives the booster 250 to perform a boosting operation, compulsively transporting the water from the reservoir 240 to the top-layer micro-channels of the gas/water distributor 220 via the booster 250. Here, the water flowing through the top-layer micro-channels of the gas/water distributor 220 transforms into micro-drops approximating to water steam. The micro-drops approximating to water steam uniformly flow into the bottom-layer micro-channels of the gas/water distributor 220, uniformly mixing with the hydrogen. The uniformly mixed hydrogen and micro-drops then enter the hydrogen fuel cell module 210, performing a redox reaction. Specifically, partially unused hydrogen and micro-drops are collected by the gas/water confluent device 280 and further enter the first output pipe 291 and second output pipe 292. Then, the controller 296 drives the electromagnetic valve 295 to open, discharging the hydrogen and water to the exterior of the hydrogen fuel cell system 200 via the second output pipe 292. Accordingly, by repeatedly operating the booster 250 and electromagnetic valve 295, the redox reaction can be continuously performed in the hydrogen fuel cell module 210, outputting electric power.

In conclusion, the disclosed hydrogen fuel cell systems provide many advantages. Because heaters, temperature controllers, thermal insulation members, thermometers, level monitors, and hygrometers are not required by the disclosed hydrogen fuel cell systems, overall manufacturing costs of the disclosed hydrogen fuel cell systems are reduced. Moreover, as each of the disclosed hydrogen fuel cell systems uses only a controller to humidify the hydrogen, operation and control thereof are simplified. Additionally, the disclosed hydrogen fuel cell systems can be instantly operated as required, such that operational delay and energy-consuming problems can be prevented.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A hydrogen fuel cell system, comprising:
a hydrogen fuel cell module;
a gas/water distributor connecting to the hydrogen fuel cell module;
a hydrogen input pipe connecting to the gas/water distributor, inputting hydrogen thereinto;
a reservoir receiving water;
a water input pipe connecting the gas/water distributor to the reservoir;
a pump connected to the water input pipe, transporting the water from the reservoir to the gas/water distributor;
a gas/water confluent device connecting to the hydrogen fuel cell module, wherein the hydrogen fuel cell module is disposed between the gas/water distributor and the gas/water confluent device; and
an output pipe connecting the gas/water confluent device to the reservoir.

2. The hydrogen fuel cell system as claimed in claim 1, further comprising an electromagnetic valve connected to the output pipe.

3. The hydrogen fuel cell system as claimed in claim 2, further comprising a controller electrically connected to the pump and electromagnetic valve, controlling operation thereof.

4. The hydrogen fuel cell system as claimed in claim 1, further comprising a check valve connected to the water input pipe and disposed between the reservoir and the pump.

5. The hydrogen fuel cell system as claimed in claim 1, wherein the reservoir comprises an exhaust, discharging gas to the exterior of the reservoir.

6. The hydrogen fuel cell system as claimed in claim 5, wherein the exhaust comprises a gas/liquid separation film.

7. A hydrogen fuel cell system, comprising:
a hydrogen fuel cell module;
a gas/water distributor connecting to the hydrogen fuel cell module;
a hydrogen input pipe connecting to the gas/water distributor, inputting hydrogen thereinto;
a reservoir receiving water;
a booster connected to the gas/water distributor;
a water input pipe connecting the reservoir to the booster, inputting the water from the reservoir into the booster and gas/water distributor;
a gas/water confluent device connecting to the hydrogen fuel cell module, wherein the hydrogen fuel cell module is disposed between the gas/water distributor and the gas/water confluent device; and
a first output pipe connecting the gas/water confluent device to the reservoir.

8. The hydrogen fuel cell system as claimed in claim 7, further comprising a second output pipe and an electromagnetic valve, wherein the second output pipe is connected to the first output pipe, and the electromagnetic valve is connected to the second output pipe.

9. The hydrogen fuel cell system as claimed in claim 8, further comprising a controller electrically connected to the electromagnetic valve and booster, controlling operation thereof.

10. The hydrogen fuel cell system as claimed in claim 7, further comprising a first check valve connected to the water input pipe.

11. The hydrogen fuel cell system as claimed in claim 7, further comprising a second check valve connected to the first output pipe.
